(19) United States
(12) Patent Application Publication
(10) Pub. No.: US 2013/0336701 A1
(43) Pub. Date: Dec. 19, 2013

(54) PAPER OUTPUTTING APPARATUS FOR PRINTING APPARATUS

(71) Applicant: HON HAI PRECISION INDUSTRY CO., LTD., (US)

(72) Inventors: TZU-CHIEN CHU, New Taipei (TW); WEN-CHUNG LO, New Taipei (TW); CHIN-TA MA, New Taipei (TW); HSIN-HSIEN KUO, New Taipei (TW)

(73) Assignee: HON HAI PRECISION INDUSTRY CO., LTD., New Taipei (TW)

(21) Appl. No.: 13/863,517

(22) Filed: Apr. 16, 2013

(30) Foreign Application Priority Data
Jun. 13, 2012 (TW) 101121187

(51) Int. Cl. B41J 13/00

(52) U.S. Cl. CPC B41J 13/00
USPC 400/578

(57) ABSTRACT

A paper outputting apparatus for supporting a plurality of papers output from a paper output port of a printing apparatus includes a supporting bracket, two paper output slides slidably mounted on the supporting bracket, and a paper pressing slide slidably mounted on the supporting bracket. When a sheet of paper slides out from the paper output port, the two paper output slides slide to an outside of the paper output port from the supporting bracket. The paper pressing slide moves toward the paper in the paper output port to resist against the paper. The paper is curved by the paper pressing slide and slides out from the paper output port along the two paper output slides.

### BACKGROUND

1. Technical Field

The present disclosure relates to a paper outputting apparatus for a printing apparatus.

2. Description of Related Art

A printing apparatus, such as a printer or a photocopying machine, feeds a sheet of paper from an input tray, prints an image on the sheet, and discharges the printed sheet to an output tray. In most office settings, a single printing apparatus is used by several users. A large number of paper sheets may be laid on the output tray of the printing apparatus. The printed sheets may become bent during the printing process, causing the sheets jammed in the printing apparatus. When a user tries to pull the jammed sheets out of the printing apparatus, the jammed sheets may tear. Shreds from the torn sheets may remain in the printing apparatus and the printing apparatus remains non-operational.

Therefore there is a need for improvement in the art.

### BRIEF DESCRIPTION OF THE DRAWINGS

FIG. 1 is an isometric view of a paper outputting apparatus for printing apparatuses, in accordance with an embodiment.

FIG. 2 is an exploded view of the paper outputting apparatus for printing apparatuses; the paper outputting apparatus comprises a supporting bracket, a paper pressing slide, a first gear, two paper output slides, and two third gears.

FIG. 3 is an isometric view of the paper pressing slide and the first gear of FIG. 2.

FIG. 4 is an enlarged view of a circled portion IV of FIG. 2.

FIG. 5 is an assembled view of the supporting bracket, the paper pressing slide, the first gear, the paper output slides, and the third gears of FIG. 2.

FIG. 6 is an isometric view of the paper output slide of FIG. 2.

FIG. 7 is a cross-sectional view of the paper outputting apparatus for printing apparatus of FIG. 1, taken along line VII-VII.

FIG. 8 is a cross-sectional view of the paper outputting apparatus for printing apparatus of FIG. 2, with a sheet of paper being output from the paper output slides.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

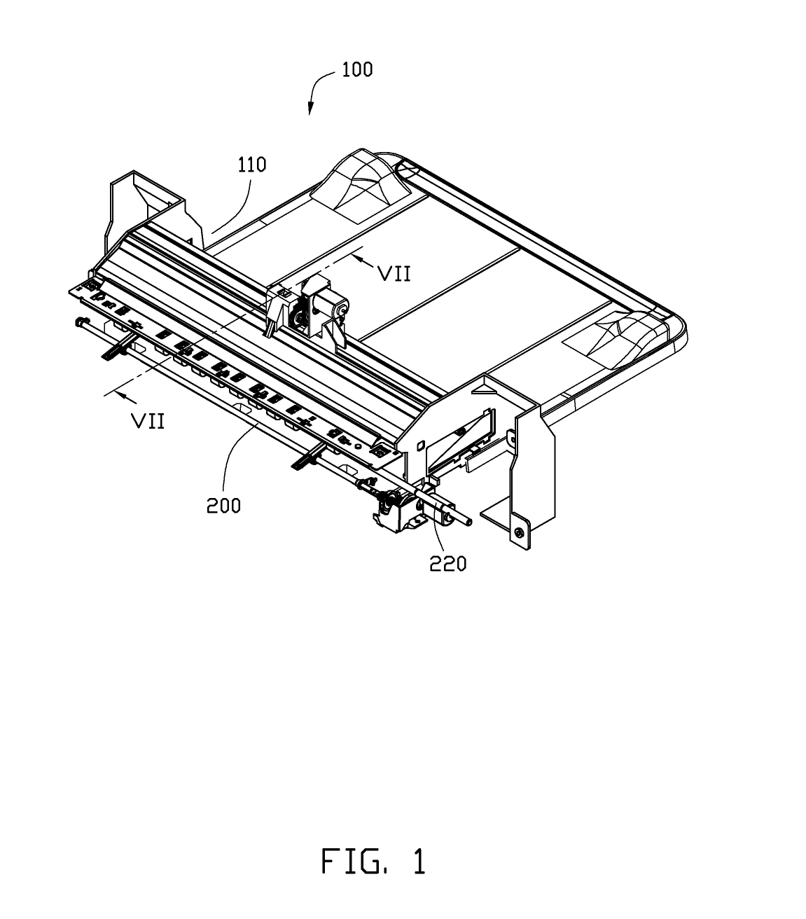

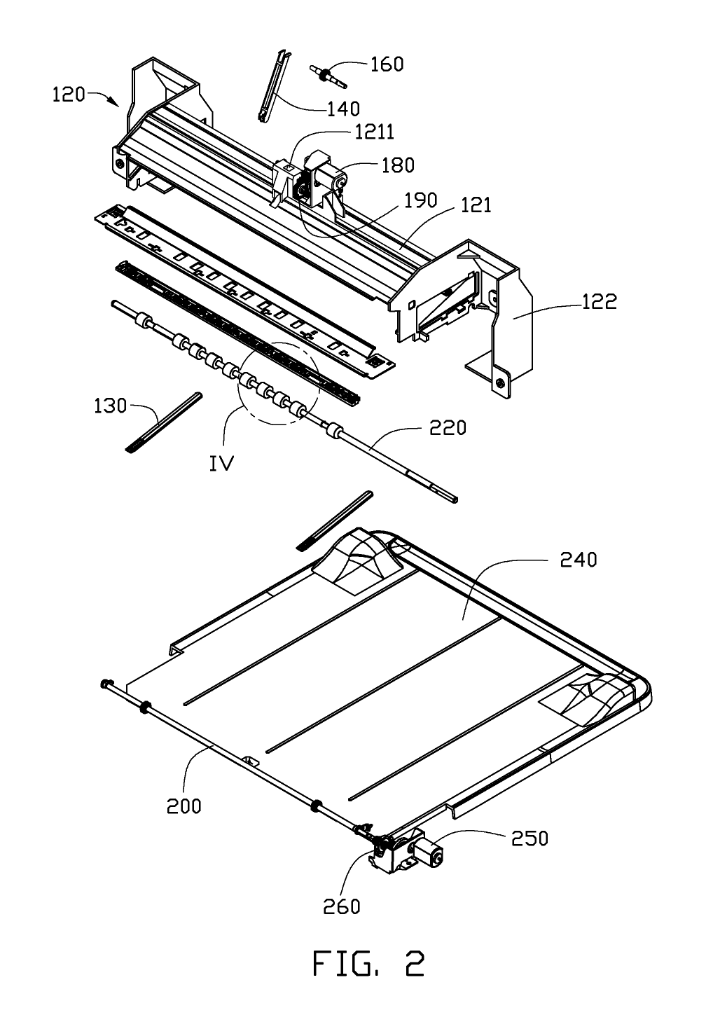

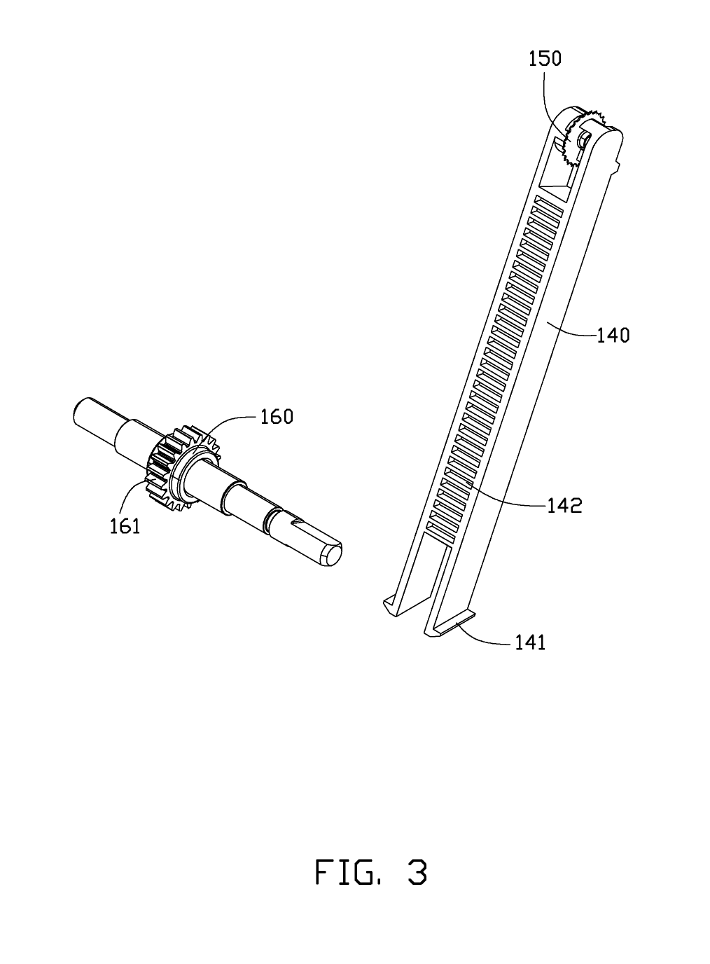

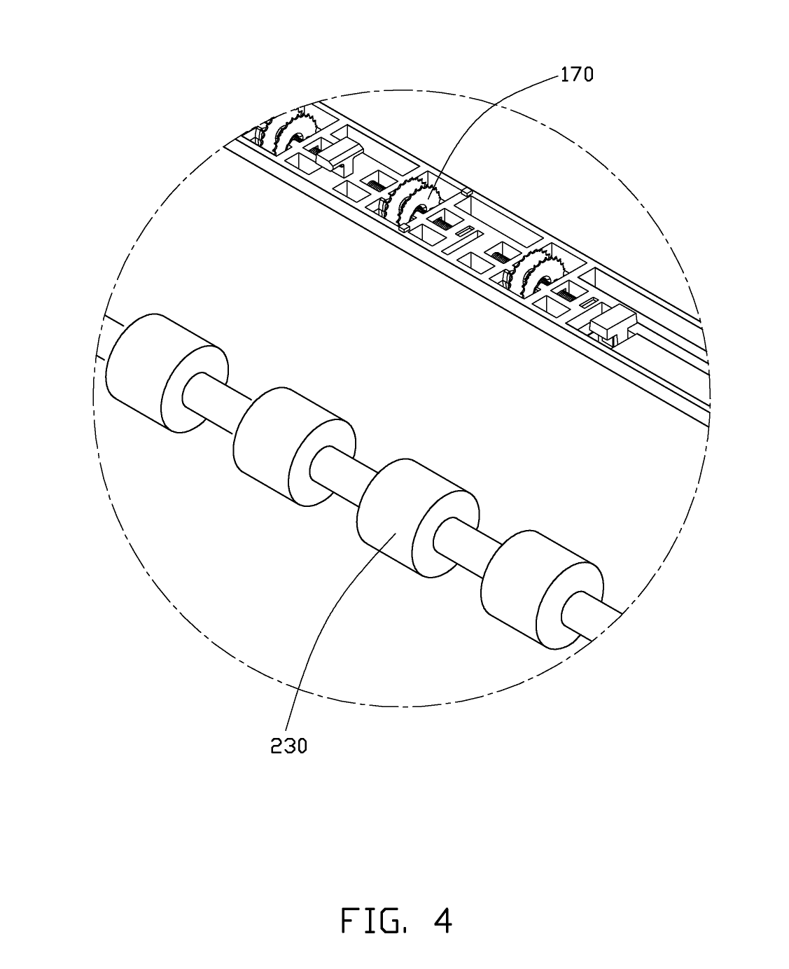

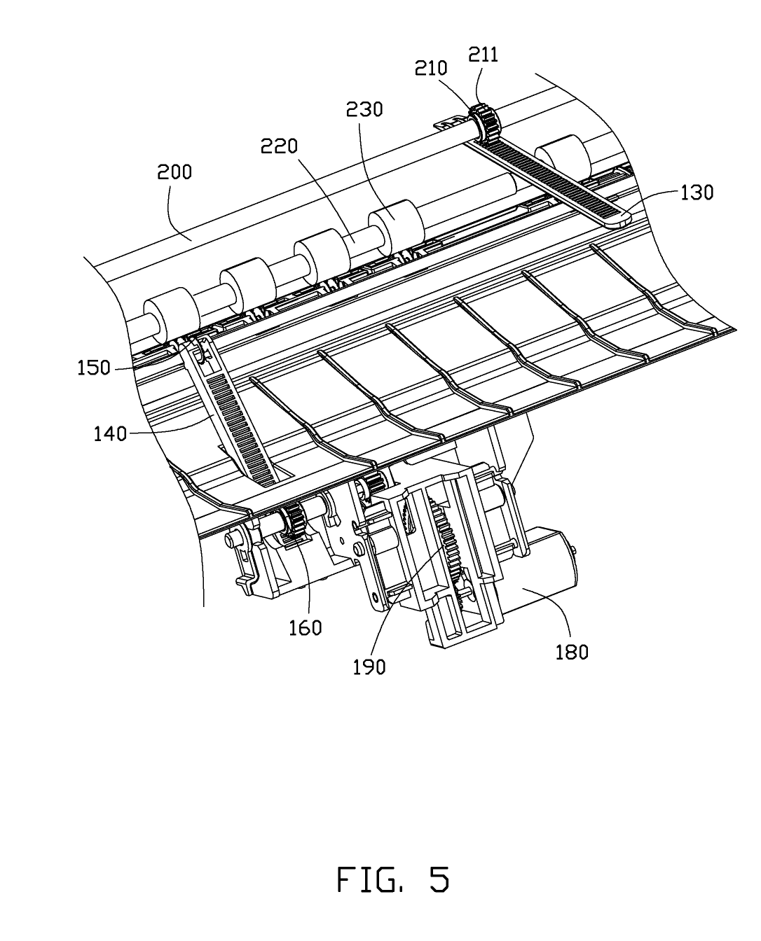

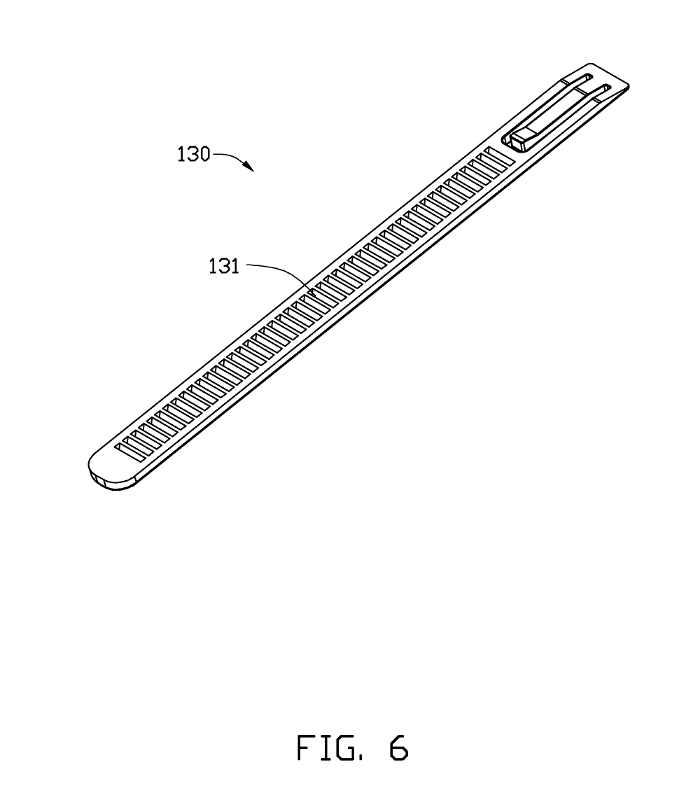

Referring FIGS. 1 to 6, a paper outputting apparatus for printing apparatuses supports a plurality of papers (not shown) output from a paper output port 110 of a printing apparatus 100.

The paper outputting apparatus includes a supporting bracket 120, two paper output slides 130 mounted on the supporting bracket 120, and a paper pressing slide 140 mounted on the supporting bracket 120.

The supporting bracket 120 comprises a top wall 121 and two side walls 122 perpendicular to the top wall 121. An accommodating portion 1211 is formed in the top wall 121 corresponding to the paper pressing slide 140. A paper pressing wheel 150 is located on a first end of the paper pressing slide 140. Two trapezoid-shaped hooks 141 perpendicularly extend from a second end of the paper pressing slide 140. The first end of the paper pressing slide 140 passes through the accommodating portion 1211 with the two hooks 141 locked on the top wall 121. A plurality of rod-shaped first engaging slots 142 are defined in the paper pressing slide 140. A first gear 160 is located on one side of the accommodating portion 1211. A plurality of first teeth 161 are defined in the first gear 160. The plurality of first teeth 161 engage with the plurality of rod-shaped first engaging slots 142. A plurality of paper output wheels 170 are located on another side of the accommodating portion 1211. A first motor 180 and a plurality of second gears 190 are located on the top wall 121 adjacent to the accommodating portion 1211. The plurality of second gears 190 are connected to the first motor 180 and the first gear 160.

A first rotation axis 200 is located on the two side walls 122. Two third gears 210 are located on the first rotation axis 200 corresponding to the two paper output slides 130. A plurality of second teeth 211 are defined in each of the two third gears 210. A plurality of rod-shaped second engaging slots 131 are defined in each of the two paper output slides 130. The plurality of second teeth 211 on each of the two third gears 210 engage with the plurality of second engaging slots 131 on the corresponding paper output slides 130. A second rotation axis 220 is located on the two side walls 122. A plurality of paper output rollers 230 are located on the second rotation axis 220. A paper supporting tray 240 is located between the two side walls 122. The paper supporting tray 240 is parallel to the top wall 121. A second motor 250 and a plurality of fourth gears 260 are located on one of the two side walls 122. The plurality of fourth gears 260 are connected to the second motor 250 and the first rotation axis 200.

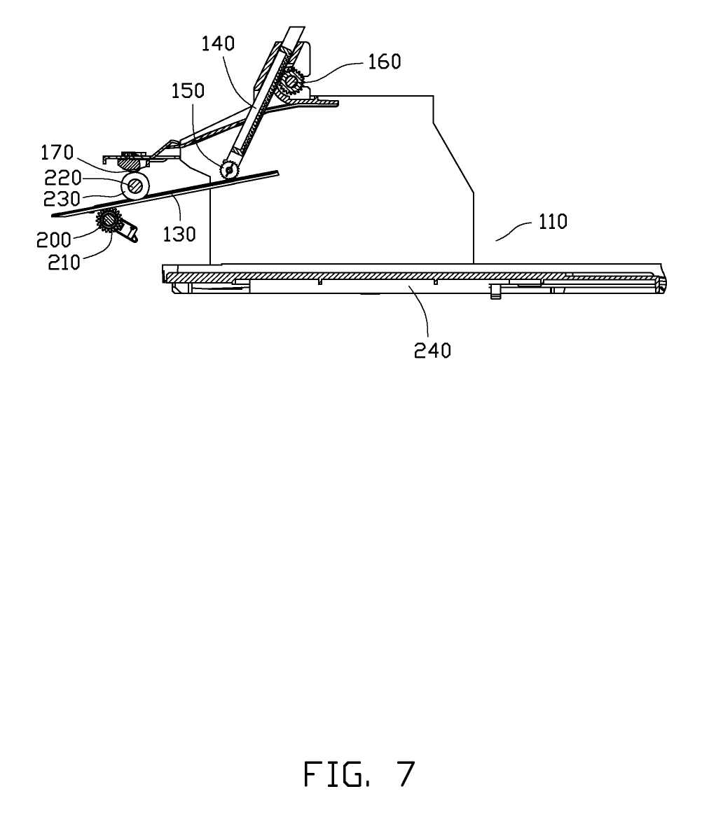

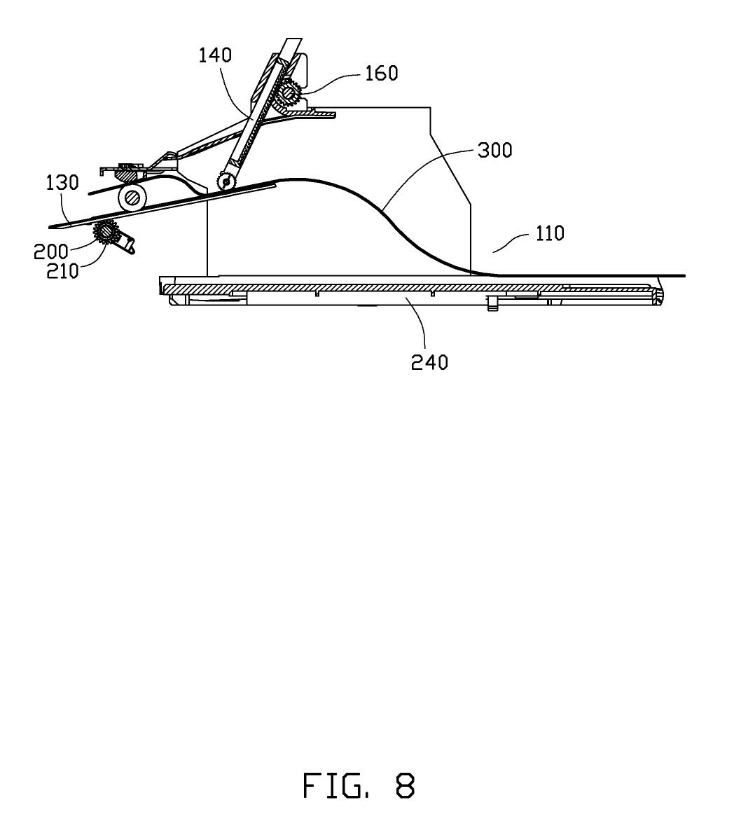

FIGS. 7 and 8 show that while working, the second rotation axis 220 rotates to output the paper, the plurality of paper output rollers 230 rotate with the second rotation axis 220. A paper 300 in the paper output port 110 slides out between the plurality of paper output wheels 170 and the plurality of paper output rollers 230. The first motor 180 is powered on and drives the first gear 160 to rotate along a first direction via the plurality of second gears 190. The first gear 160 drives the paper pressing slide 140 to move toward the paper supporting tray 240 in the accommodating portion 1211. The second motor 250 is powered on and drives the first rotation axis 200 to rotate along a second direction opposite to the first direction via the plurality of fourth gears 260. The two third gears 210 rotate along the second direction together with the first rotation axis 200. The two third gears 210 drive the corresponding paper output slides 130 to slide to an outside of the paper output port 110 from the supporting bracket 120. The paper pressing slide 140 resists against the paper 300 in the paper output port 110 via the paper pressing wheel 150. The paper 300 is bent into a curve by the paper pressing slide 140. The paper 300 slides out from the paper output port 110 along the two paper output slides 130 and is dropped on the paper supporting tray 240.

As the paper 300 in the paper output port 110 is bent into a curve by the paper pressing slide 140, the lengthwise rigidity of the paper 300 is increased. Typically, the rigidity of the paper 300 is represented by a moment of inertia which is inversely proportional to the movement of the paper 300 subject to an external force. When the rigidity of the paper 300 is increased, more force is required to move an individual sheet of paper. The ability of the paper 300 to resist an external force is strengthened and the paper 300 will be less readily disturbed on the paper supporting tray 240. The printing papers can be easily removed from the paper output port 110 and will not be caught in the printing apparatus. Therefore, malfunctions of the printing apparatus can be avoided.

When the printing is complete, the first motor 180 drives the first gear 160 rotating along the second direction via the plurality of second gears 190. The first gear 160 drives the paper pressing slide 140 to move away from the paper supporting tray 240 in the accommodating portion 1211. The second motor 250 drives the first rotation axis 200 and the two third gears 210 rotating along the first direction via the plurality of fourth gears 260. The two third gears 210 drives the corresponding paper output slides 130 sliding to an inside of the paper output port 110 on the supporting bracket 120

Even though numerous characteristics and advantages of the present disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. A paper outputting apparatus for a printing apparatus comprising:
a supporting bracket;
two paper output slides slidably mounted on the supporting bracket;
a paper pressing slide slidably mounted on the supporting bracket; and
a paper output port; wherein when a sheet of paper slides out from the paper output port, the two paper output slides slide to an outside of the paper output port from the supporting bracket; the paper pressing slide moves toward the sheet in the paper output port to resist against the sheet; and the paper pressing slide curves the sheet and slides the sheet out to the paper output port along the two paper output slides.

2. The paper outputting apparatus of claim 1, wherein a plurality of rod-shaped first engaging slots are defined in the paper pressing slide; a first gear is located on the supporting bracket; a plurality of first teeth are formed in the first gear; and the plurality of first teeth engage with the plurality of rod-shaped first engaging slots to drive the paper pressing slide sliding on the supporting bracket.

3. The paper outputting apparatus of claim 2, wherein a paper pressing wheel is located on a first end of the paper pressing slide; and the paper pressing slide resists against the sheet of paper in the paper output port via the paper pressing wheel.

4. The paper outputting apparatus of claim 3, wherein the supporting bracket includes a top wall and two side walls perpendicular to the top wall; an accommodating portion is formed in the top wall corresponding to the paper pressing slide; two trapezoid-shaped hooks perpendicularly extend from a second end of the paper pressing slide; the first end of the paper pressing slide passes through the accommodating portion with the two hooks locked on the top wall; and the first gear is located on the top wall and on one side of the accommodating portion.

5. The paper outputting apparatus of claim 4, wherein a first motor and a plurality of second gears are located on the top wall adjacent to the accommodating portion; the plurality of second gears are connected to the first motor and the first gear; and the first motor drives the first gear rotating via the plurality of second gears.

6. The paper outputting apparatus of claim 5, wherein a first rotation axis is located on the two side walls; two third gears are located on the first rotation axis corresponding to the two paper output slides; a plurality of second tooth are formed in each of the two third gears; a plurality of rod-shaped second engaging slots are defined in each of the two paper output slides; and the plurality of second tooth on each of the two third gears engage with the plurality of second engaging slots on the corresponding paper output slides to drive the paper output slides sliding to an outside of the paper output port from the supporting bracket.

7. The paper outputting apparatus of claim 6, wherein a second motor and a plurality of fourth gears are located on one of the two side walls; the plurality of fourth gears are connected to the second motor and the first rotation axis; the second motor drives the first rotation axis rotating via the plurality of fourth gears; and the two third gears rotate together with the first rotation axis.

8. The paper outputting apparatus of claim 7, wherein a plurality of paper output wheels are located on another side of the accommodating portion; a second rotation axis is located on the two side walls; a plurality of paper output rollers are located on the second rotation axis; and the paper in the paper output port slides out between the plurality of paper output wheels and the plurality of paper output rollers.

9. The paper outputting apparatus of claim 8, wherein a paper supporting tray is located between the two side walls; the paper supporting tray is parallel to the top wall; and the paper slides out from the paper output port is dropped on the paper supporting tray.

10. A paper outputting apparatus for supporting a plurality of papers output from a paper output port of a printing apparatus comprising:
a supporting bracket;
two paper output slides slidably mounted on the supporting bracket; and
a paper pressing slide slidably mounted on the supporting bracket; wherein when a sheet of paper slides out from the paper output port, the two paper output slides slide to an outside of the paper output port from the supporting bracket; the paper pressing slide moves toward the sheet in the paper output port to resist against the sheet; and the paper pressing slide curves the sheet and slides the sheet out to the paper output port along the two paper output slides.

11. The paper outputting apparatus of claim 10, wherein a plurality of rod-shaped first engaging slots are defined in the paper pressing slide; a first gear is located on the supporting bracket; a plurality of first teeth are formed in the first gear; and the plurality of first teeth engage with the plurality of rod-shaped first engaging slots to drive the paper pressing slide sliding on the supporting bracket.

12. The paper outputting apparatus of claim 11, wherein a paper pressing wheel is located on a first end of the paper pressing slide; and the paper pressing slide resists against the sheet of paper in the paper output port via the paper pressing wheel.

13. The paper outputting apparatus of claim 12, wherein the supporting bracket includes a top wall and two side walls perpendicular to the top wall; an accommodating portion is formed in the top wall corresponding to the paper pressing slide; two trapezoid-shaped hooks perpendicularly extend from a second end of the paper pressing slide; the first end of the paper pressing slide passes through the accommodating portion with the two hooks locked on the top wall; and the first gear is located on the top wall and on one side of the accommodating portion.

14. The paper outputting apparatus of claim 13, wherein a first motor and a plurality of second gears are located on the top wall adjacent to the accommodating portion; the plurality of second gears are connected to the first motor and the first gear; and the first motor drives the first gear rotating via the plurality of second gears.

15. The paper outputting apparatus of claim 14, wherein a first rotation axis is located on the two side walls; two third gears are located on the first rotation axis corresponding to the two paper output slides; a plurality of second tooth are formed in each of the two third gears; a plurality of rod-shaped second engaging slots are defined in each of the two paper output slides; and the plurality of second tooth on each of the two third gears engage with the plurality of second engaging slots on the corresponding paper output slides to drive the paper output slides sliding to an outside of the paper output port from the supporting bracket.

16. The paper outputting apparatus of claim 15, wherein a second motor and a plurality of fourth gears are located on one of the two side walls; the plurality of fourth gears are connected to the second motor and the first rotation axis; the second motor drives the first rotation axis rotating via the plurality of fourth gears; and the two third gears rotate together with the first rotation axis.

17. The paper outputting apparatus of claim 16, wherein a plurality of paper output wheels are located on another side of the accommodating portion; a second rotation axis is located on the two side walls; a plurality of paper output rollers are located on the second rotation axis; and the paper in the paper output port slides out between the plurality of paper output wheels and the plurality of paper output rollers.

18. The paper outputting apparatus of claim 17, wherein a paper supporting tray is located between the two side walls; the paper supporting tray is parallel to the top wall; and the paper slides out from the paper output port is dropped on the paper supporting tray.
